(19) United States
(12) Patent Application Publication
(10) Pub. No.: US 2009/0204326 A1
(43) Pub. Date: Aug. 13, 2009

(54) Method and System for Supporting the Driver of a Motor Vehicle in Recognizing the Surroundings of the Motor Vehicle

(76) Inventors: Werner Knee, Esslingen (DE); Ralf Render, Leonberg (DE); Tobias Stumber, Rutesheim (DE)

Correspondence Address: KENYON & KENYON LLP, ONE BROADWAY, NEW YORK, NY, 10004, US

(21) Appl. No.: 12/083,299

(22) PCT Filed: Sep. 7, 2006
(86) PCT No.: PCT/EP2006/066123

§ 371 Date: Jan. 22, 2009

(30) Foreign Application Priority Data
Oct. 10, 2005 (DE) 10 2005 048 336.4

(51) Int. Cl. G06G 7/78

(52) U.S. Cl. 701/300

(57) ABSTRACT

A method for supporting the driver of a motor vehicle in recognizing the surroundings of the motor vehicle, the surroundings of the motor vehicle being recorded visually by an image sensor unit, graphic supplemental information being produced by a control unit and/or recalled from a storage arrangement, both the recorded surroundings data and the graphic supplemental information being depicted visually on a display unit, and the graphic supplemental information and/or the collected surroundings data being displayed semi-transparently. A system that is suitable for carrying out the method and that includes an image sensor unit for visually recording the surroundings, a control unit for producing or recalling graphic supplemental information, as well as a display unit for visually displaying the collected surroundings data and the graphic supplemental information, and the graphic supplemental information and/or the collected surroundings data being portrayable semi-transparently on the display unit.

### FIELD OF THE INVENTION

The present invention relates to a method for supporting the driver of a motor vehicle in recognizing the surroundings of the motor vehicle, the surroundings of the motor vehicle being recorded visually by an image sensor unit, graphic supplemental information being produced by a control unit and/or recalled from a storage unit, and both the surroundings data and the graphic supplemental information being depicted visually on a display unit.

### BACKGROUND INFORMATION

To support drivers of motor vehicles, video-based driver assistance systems which use a display may be used to depict images recorded by a camera. In this way, when backing into a parking spot the driver may be supported for example with a backing camera system in recognizing parking space limitations or obstructions. Through the use of infrared-sensitive image sensors, for example according to WO 2004/047449 A1, with so-called night view systems, the driver may even be supported in circumstances of poor visibility or bad weather conditions.

To support the driver even further with such assistance systems, it is also known to produce or recall additional information and to add it supplementarily to the images recorded by the image sensor unit and exhibited on the display unit. For example, with a night view system having integrated lane recognition it is possible to show the vehicle's lane, or with a backing camera system reference lines may be shown visually on the display unit to make the parking process easier. Symbols or texts may also be produced and displayed as additional information. Here, artificially generated graphic data are always portrayed on a display unit simultaneously with the recorded images of the real surroundings of the vehicle. A display or monitor may function as the display unit.

In the known systems, graphic supplemental information is displayed by simply overwriting the pixels of the image recorded by the camera or image sensor unit. The originally recorded picture data are overwritten in this process by the data of the supplemental information that is to be shown, so that part of the recorded surroundings data is covered.

### SUMMARY OF THE INVENTION

An object of the exemplary embodiments and/or exemplary methods of the present invention is thus in general to create an improved method or driver assistance system of the type named at the outset, in which the supplemental information is readily recognizable and at the same time covers and diverts as little as possible of the recorded surroundings image, so that the driver is supported optimally.

Compared to the methods and systems discussed in the Background Information, the method according to the present invention has the advantage that the actual image information is not covered by the supplemental information, and yet the graphic supplemental information may be portrayed visually on the display unit in any size desired. There is therefore good recognizability of both the recorded surroundings data and of the supplemental information, which results in particularly effective support of the driver.

The underlying idea of the exemplary embodiments and/or exemplary methods of the present invention is that the graphic supplemental information and/or the collected surroundings data are portrayed semi-transparently on the display unit.

In this way, the recorded surroundings data and the graphic supplemental information may be displayed in their entirety, without certain areas of the data to be displayed being completely covered and unrecognizable for the driver. The driver may therefore benefit to the fullest extent from both sets of information portrayed on the display unit, so that optimal support is ensured.

Advantageous refinements of and improvements on the method according to the present invention are also described herein.

It is particularly advantageous if the graphic supplemental information is superimposed on the collected surroundings data in a semi-transparent manner. The areas of the surroundings image recorded by the image sensor unit which were covered in the traditional systems by the displayed supplemental information are consequently visible.

According to an exemplary embodiment of the present invention, the graphic supplemental information is superimposed on the collected surroundings data to a variable extent. In this way the degree of transparency may be varied and adapted to different conditions or needs.

At the same time, according to a first variant according to the exemplary embodiments and/or exemplary methods of the present invention, the variable part of the graphic supplemental information to be superimposed may be predefined selectively. This gives the driver the possibility of configuring the system according to his wishes and preferences.

A second specific embodiment may include the provision that at least one predetermined parameter of the situation of the vehicle is captured, and that the variable part of the graphic supplemental information to be superimposed varies as a function of the value of the at least one parameter. The degree of transparency of the superimposed supplemental information may thus be adapted to certain driving conditions of the motor vehicle, which may be to the momentary speed and/or to the acceleration or deceleration of the motor vehicle, and/or to the momentary steering angle of the vehicle. For example, reference lines for a back-in parking maneuver may be overlaid more visibly on the image of the surroundings behind the vehicle if the steering wheel is turned substantially, or the reference lines may be overlaid with greater transparency and less visibility if the steering angle is smaller.

Another variant embodiment may likewise provide that at least one predetermined parameter of the surroundings is registered, for example the nature of the road on which the vehicle is currently traveling or the state of the surroundings, in particular the brightness of the surroundings, and that the variable part of the graphic supplemental information to be superimposed varies as a function of the at least one parameter value. For example, the degree of transparency of the superimposed image contents may be displayed differently on freeways than when driving in a built-up area. It is also possible to increase the degree of transparency of the graphic supplemental information to be superimposed as the brightness decreases, i.e., these data are displayed less clearly visibly in order to improve the depiction of the recorded surroundings image, while in contrast, if the brightness of the surroundings increases the graphic supplemental information is emphasized more strongly, in order to increase its recognizability.

Furthermore, it is particularly advantageous if the image contents of the graphic supplemental information and of the collected surroundings data which are to be superimposed on each other are each weighted with a factor, and the image contents thus weighted are added up in a display controller before being portrayed on the display unit. In this way it is particularly easy to vary the overlaid part of the data.

The image data may be displayed on the display unit in a pixel matrix, the pixels of the graphic supplemental information and the pixels of the collected surroundings data being displayed in the picture areas where superimposition occurs in a relative quantity ratio that corresponds to the degree of transparency or to the weighting factor that may have been formed. At the same time, the pixels of the two images to be superimposed on each other are advantageously distributed as uniformly as possible, in order to obtain uniform recognizability in the desired degree of transparency. With a semi-transparent portrayal having a transparency of 50%, for example, the pixels of the collected surroundings data and the pixels of the graphic supplemental information may for example be displayed alternately in a checkerboard pattern.

It is particularly advantageous if the control unit includes a module that is designed as a program of a microprocessor. In that respect, another object of the exemplary embodiments and/or exemplary methods of the present invention is a computer program having program code arrangement for carrying out the steps of the method according to one of the preceding claims when the program is run on a computer.

In addition, the exemplary embodiments and/or exemplary methods of the present invention also relates to a system that is appropriate for carrying out the method according to the present invention. Such a system advantageously includes storage arrangement in which a computer program that carries out the method according to the present invention is storable.

In particular, a driver assistance system corresponding to the method described earlier includes an image sensor unit, which may be a video camera, for visually capturing the surroundings, a control unit to produce or recall graphic supplemental information, and a display unit for visual portrayal of the collected surroundings data and the graphic supplemental information, the graphic supplemental information and/or the collected surroundings data being portrayable semi-transparently on the display unit. The graphic supplemental information may be newly generated by the control unit for each instance of application, and/or it may be stored in advance in a storage medium and recalled by the storage unit as needed.

Above and beyond the use in conventional motor vehicles, such systems may also be employed in particular in rail vehicles or in air or water craft.

Exemplary embodiments of the present invention are illustrated in the drawings, and will be explained in greater detail in the following description.

### BRIEF DESCRIPTION OF THE DRAWINGS

FIG. 1 shows a block diagram of a system for carrying out the method according to the present invention.

FIG. 2 shows a portrayal of data according to the present invention on a screen of a display unit.

### DETAILED DESCRIPTION

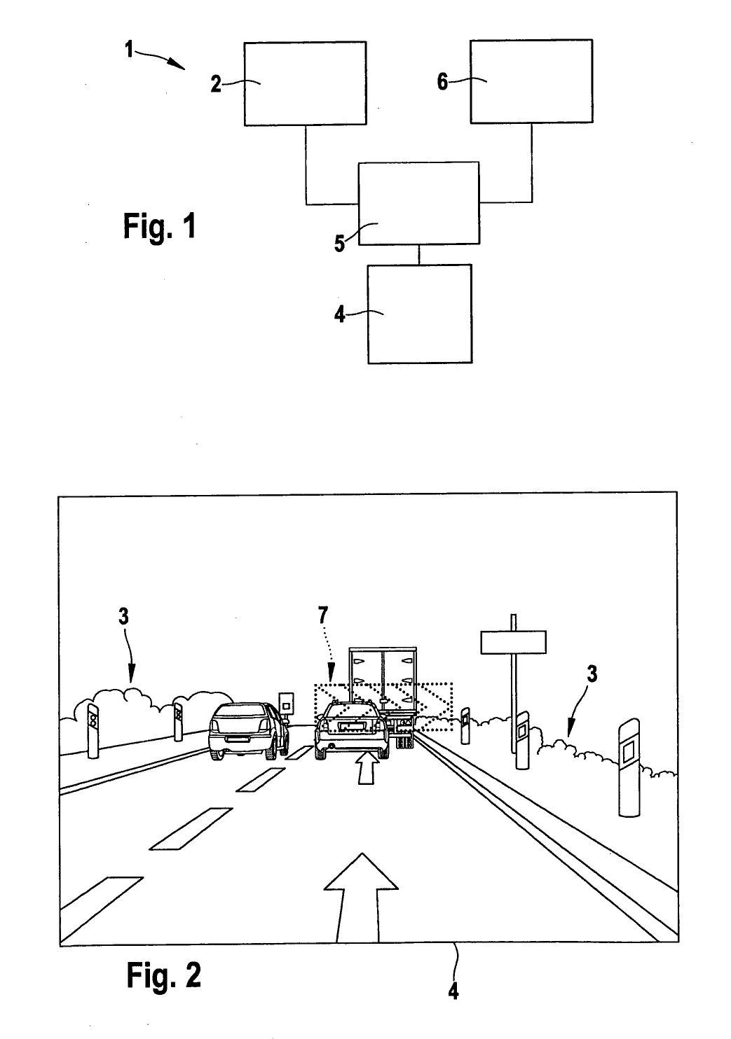

Driver assistance system 1, depicted in FIG. 1 and employed in a motor vehicle, is used to support the driver in recognizing the surroundings of the vehicle. It may be a night view system, for example. It includes a video camera 2, with which the surroundings 3 in front of the vehicle may be captured visually, and a display 4 as the display unit on which the images of the surroundings 3 captured by video camera 2 may be displayed. Display 4 is controlled by a control unit 5, which processes the image data supplied by video camera 2 as appropriate in a form desired by the driver and forwards it to display 4 to be displayed.

In addition, there is also a storage unit 6 in which certain supplemental information is stored, which may be recalled by control unit 5 as needed and likewise displayed visually on display 4 as graphic supplemental information 7. For example, impending changes of travel direction may be recognized by a navigation system connected to driver assistance system 1 and may be portrayed as graphic supplemental information 7 on display 4 using appropriate symbols.

In so doing, graphic supplemental information 7 is superimposed semi-transparently by control unit 5 on surroundings data 3 captured by video camera 2, so that the image of surroundings 3 is still recognizable in the background through graphic supplemental information 7. As shown in FIG. 2, graphic supplemental information 7, which here is in the form of right-pointing arrows indicating a right-hand curve some distance away, is easily visible but without covering the images of surroundings 3 behind them, here essentially two preceding vehicles. In this way the driver may be supported particularly effectively by driver assistance system 1.

1-10. (canceled)

11. A method for supporting a driver of a motor vehicle in recognizing surroundings of the motor vehicle, the method including:
visually capturing the surroundings of the motor vehicle using an image sensor unit;
at least one of producing and recalling graphic supplemental information using a control unit; and
visually portraying collected surroundings data and the graphic supplemental information on a display unit;
wherein the at least one of the graphic supplemental information and the collected surroundings data are portrayed semi-transparently on the display unit.

12. The method of claim 11, wherein the graphic supplemental information is superimposed semi-transparently on the collected surroundings data.

13. The method of claim 12, wherein the graphic supplemental information is superimposed on the collected surroundings data to a variable extent.

14. The method of claim 13, wherein the variable part of the graphic supplemental information to be superimposed is predefined selectively.

15. The method of claim 13, wherein at least one predetermined parameter of a status of the motor vehicle, including at least one of a momentary speed, acceleration or deceleration of the motor vehicle and a momentary steering angle of the motor vehicle, is recorded, and a variable part of the graphic supplemental information to be superimposed varies as a function of the at least one parameter.

16. The method of claim 13, wherein at least one predetermined parameter of the motor vehicle surroundings or of a brightness status of the motor vehicle surroundings is recorded, and a variable part of the graphic supplemental information to be superimposed varies as a function of the at least one parameter.

17. The method of claim 11, wherein image contents of the graphic supplemental information and of the collected surroundings data to be superimposed on each other are each weighted with a factor, and the weighted image contents are added up before being displayed.

18. The method of claim 11, wherein the image data are displayed in a pixel matrix, and wherein pixels of the graphic supplemental information and pixels of the collected surroundings data are portrayed in picture areas superimposed on each other on the display unit, and are uniformly distributed, in a relative quantity ratio that corresponds to the degree of transparency or to the weighting factor that may have been formed.

19. A computer readable medium having program code that is executable by a computer processor, comprising:
a program code arrangement, including program code for supporting a driver of a motor vehicle in recognizing surroundings of the motor vehicle, by performing the following:
visually capturing the surroundings of the motor vehicle using an image sensor unit;
at least one of producing and recalling graphic supplemental information using a control unit; and
visually portraying collected surroundings data and the graphic supplemental information on a display unit;
wherein the at least one of the graphic supplemental information and the collected surroundings data are portrayed semi-transparently on the display unit.

20. A driver assistance system for a motor vehicle, comprising:
an image sensor unit for visually capturing surroundings of the motor vehicle;
a control unit for at least one of producing and recalling graphic supplemental information; and
a display unit for visually displaying collected surroundings data and the graphic supplemental information, wherein the at least one of the graphic supplemental information and the collected surroundings data are portrayable semi-transparently on the display unit.
